(19) United States
(12) Patent Application Publication
(10) Pub. No.: US 2015/0176676 A1
(43) Pub. Date: Jun. 25, 2015

(54) CENTRIFUGAL-FORCE PENDULUM

(71) Applicant: Schaeffler Technologies AG & Co. KG, Herzogenaurach (DE)

(72) Inventors: Christian Dinger, Lauf (DE); Christian Huegel, Rheinau (DE); David Schnaedelbach, Baden-Baden-Neuweier (DE); Florian Baral, Waldbronn (DE)

(21) Appl. No.: 14/414,889

(22) PCT Filed: Jul. 18, 2013
(86) PCT No.: PCT/DE2013/200064

§ 371 Date: Jan. 14, 2015

(30) Foreign Application Priority Data
Jul. 18, 2012 (DE) 10 2012 212 624.4

(51) Int. Cl. F16F 15/14

(52) U.S. Cl. CPC F16F 15/145

(57) ABSTRACT

The invention relates to a centrifugal-force pendulum having a pair of pendulum masses and a pendulum flange, in which a curved cut-out having a cut-out contour is provided, wherein the pendulum masses of the pair of pendulum masses are arranged on both sides of the pendulum flange and are connected to each other by at least one spacer pin led through the cut-out, wherein the spacer pin has a damping arrangement which comprises at least one stabilizing element and at least one elastic damping element (64), wherein the damping arrangement is designed to damp an impact of the spacer pin on the cut-out contour of the cut-out, wherein end compression of the damping element can be carried out by the impact, wherein the stabilizing element limits the end compression.

The present invention relates to a centrifugal pendulum.

### BACKGROUND

A centrifugal pendulum is known from DE 10 2011 013 232 A1, which includes a pendulum flange and pendulum masses fastened on both sides of the pendulum flange with the aid of a spacer bolt accommodated in an arc-shaped cutout of the pendulum flange, a movement of the pendulum mass pair being limited by a stop. The spacer bolt has a damping system, which includes a damping element and a ring surrounding the damping element. The ring is designed to strike a cutout contour of the cutout.

### SUMMARY OF THE INVENTION

It is an object of the present invention to increase the reliability of the centrifugal pendulum while simultaneously reducing noise emissions.

The present invention provides a centrifugal pendulum, which includes a pendulum mass pair and a pendulum flange, in which an arc-shaped cutout having a cutout contour is provided, the pendulum masses of the pendulum mass pair being situated on both sides of the pendulum flange and being connected to each other with the aid of at least one spacer bolt guided through the cutout, and the spacer bolt having a damping system, which includes at least one stabilizing element and at least one elastic damping element, and the damping system being designed to damp an impact of the spacer bolt on the cutout contour of the cutout, a compression of the damping element being able to occur, due to the impact. The stabilizing element limits the compression.

In another special specific embodiment of the present invention, the spacer bolt includes a spacer bolt body, the damping element being situated on a circumferential surface of the spacer bolt body, and the stabilizing element being situated on a front surface of the damping element.

A stabilizing element is preferably provided on each front surface of the damping element, so that the damping element is axially limited by the stabilizing element. Each front surface of the damping element may also be surrounded at least in sections by a shared stabilizing element, so that the damping element is axially limited by the stabilizing element.

In another special specific embodiment of the present invention, at least one damping element has an essentially rectangular cross section.

In another special specific embodiment of the present invention, at least one damping element has an essentially L-shaped cross section.

In another special specific embodiment of the present invention, at least one damping element has an essentially U-shaped cross section.

In another special specific embodiment of the present invention, at least one stabilizing element has a smaller outer diameter than the damping element.

In another special specific embodiment of the present invention, at least one stabilizing element surrounds an outer circumference and/or an inner circumference of the damping element at least in sections.

In another special specific embodiment of the present invention, at least one stabilizing element has a solidity which is greater than the solidity of the damping element.

### BRIEF DESCRIPTION OF THE DRAWINGS

The present invention is explained in greater detail below with reference to the figures. The same components are identified by the same reference numerals. Specifically:

FIG. 1 shows a side view of a torsional vibration damper, including a centrifugal pendulum situated thereon;

FIG. 2 shows a perspective view of the centrifugal pendulum;

FIG. 3 shows a perspective view of a cutout of the centrifugal pendulum illustrated in FIG. 2;

FIG. 4 shows a special specific embodiment of a spacer bolt of the centrifugal pendulum illustrated in FIGS. 1 through 3;

FIG. 5 shows a detail of a cross section of a centrifugal pendulum, including a spacer bolt in another special specific embodiment of the present invention;

FIG. 6 shows a detail of a cross section of a centrifugal pendulum, including a spacer bolt in another special specific embodiment of the present invention;

FIG. 7 shows a detail of a cross section of a centrifugal pendulum, including a spacer bolt in another special specific embodiment of the present invention;

FIG. 8 shows a detail of a cross section of a centrifugal pendulum, including a spacer bolt in another special specific embodiment of the present invention;

FIG. 9 shows a detail of a cross section of a centrifugal pendulum, including a spacer bolt in another special specific embodiment of the present invention;

FIG. 10 shows a detail of a cross section of a centrifugal pendulum, including a spacer bolt in another special specific embodiment of the present invention;

FIG. 11 shows a detail of a cross section of a centrifugal pendulum, including a spacer bolt in another special specific embodiment of the present invention;

FIG. 12 shows a detail of a cross section of a centrifugal pendulum, including a spacer bolt in another special specific embodiment of the present invention; and

FIG. 13 shows a detail of a cross section of a centrifugal pendulum, including a spacer bolt in another special specific embodiment of the present invention.

### DETAILED DESCRIPTION

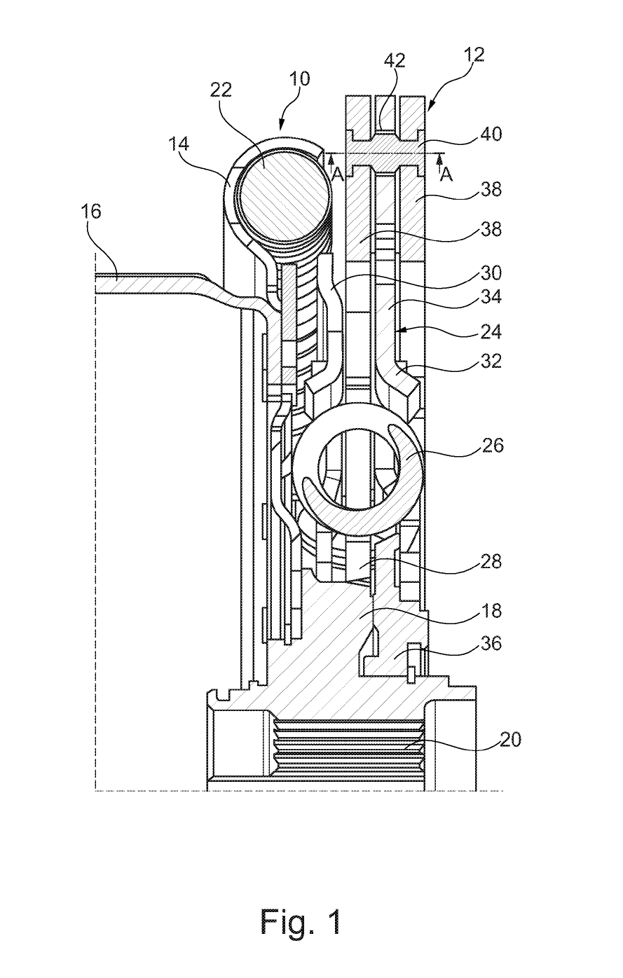

FIG. 1 shows a side view of a torsional vibration damper 10, including a centrifugal pendulum 12 situated thereon; A disk carrier 16, functioning as a clutch output of a clutch device, is situated on a damper input part 14 of a torsional vibration damper 10 designed as a series damper. The clutch device may be designed, for example, as a converter lockup clutch or as a wet clutch. Torsional vibration damper 10 is actively connected between the clutch output and an output hub 18, output hub 18 being connectable to a transmission input shaft of a transmission in a drive train of a motor vehicle via a toothing 20.

Damper input part 14 is accommodated, centered radially on the inside of output hub 18 and axially secured, and encompasses first energy storage elements 22 radially on the outside, for example bow springs, which actively connect damper input part 14 to a damper intermediate part 24, damper intermediate part 24 being restrictively rotatable with respect to damper input part 14. Damper intermediate part 24, in turn, is restrictively rotatable with respect to a damper output part 28 via the action of second energy storage elements 26 situated radially farther to the inside, for example pressure springs. Damper output part 28 is rotatably fixedly connected to output hub 18, for example via a welded connection.

Damper intermediate part 24 includes two disk parts 30, 32, which are spaced an axial distance apart and axially surround damper output part 28. The one disk part 32 is elongated radially outwardly to form a pendulum flange 34. Pendulum flange 34 is integrated into disk part 32, but may also be fastened thereto as a separate component. Pendulum flange 34 is part of centrifugal pendulum 12. Disk part 32 is rotatably fixedly connected radially on the inside to a turbine hub 36, which is designed to connect a turbine wheel of a hydrodynamic torque converter. Turbine hub 36 is centered on output hub 18 and is rotatably situated with respect thereto.

Pendulum flange 34 of centrifugal pendulum 12 accommodates, in a radially outer section, two pendulum masses 38, which are situated axially opposite each other and are connected to each other via a spacer bolt 40, spacer bolt 40 engaging with pendulum flange 34 through an arc-shaped cutout 42.

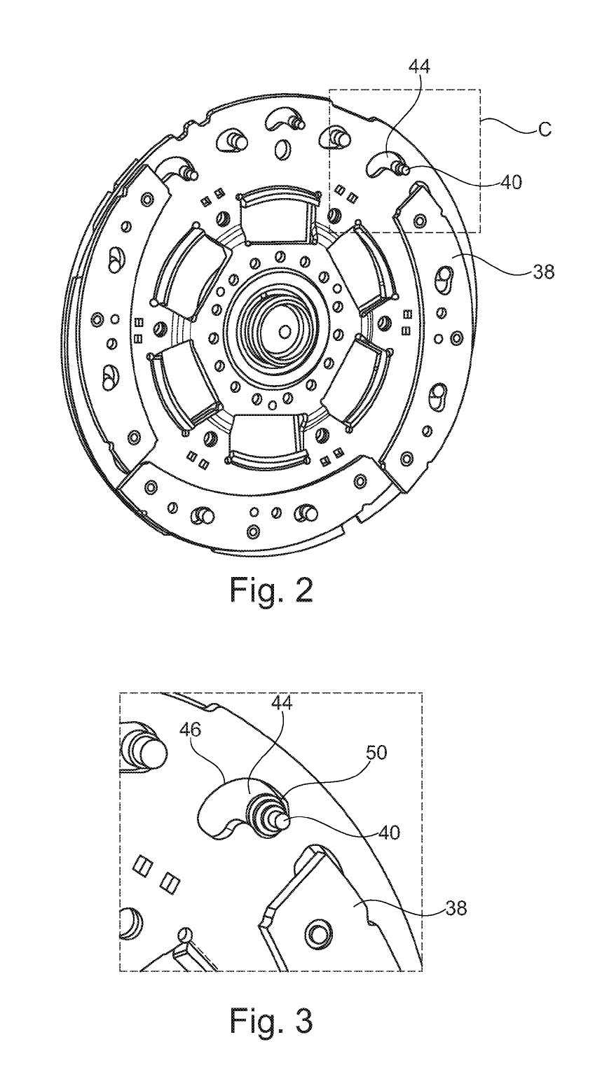

FIG. 2 shows a perspective view of centrifugal pendulum 12, and FIG. 3 shows a cutout (shown by the dashed line) of centrifugal pendulum 12, marked in FIG. 2 and identified by “C.” For the sake of better clarity, not all pendulum masses 38 are illustrated in FIGS. 2 and 3. As explained above, spacer bolt 40 engages with arc-shaped cutout 44 and thus connects pendulum masses 38 situated on both sides of pendulum flange 34. Cutout 44 illustrated in FIG. 3 has an arc-shaped cutout contour 46, which limits a mobility of spacer bolt 40 by striking against cutout contour 46 with an outer circumferential surface 50 of spacer bolt 40.

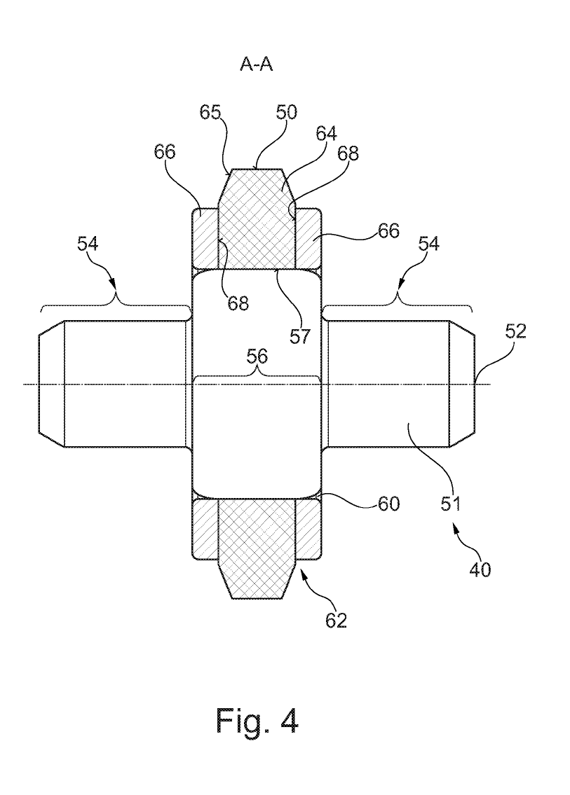

FIG. 4 shows a sectional view of a spacer bolt 40 according to one special specific embodiment of the present invention. The section runs along section line A-A illustrated in FIG. 1. Spacer bolt 40 has a spacer bolt body 51 of a rotationally symmetrical design, including a longitudinal axis 52, which may also be a rotation axis of spacer bolt 40, depending on the fastening of spacer bolt 40 to pendulum masses 38. Spacer bolt body 51 has two fastening areas 54, on which spacer bolt body 51 is connected to pendulum masses 38. Stop area 56 is situated between fastening areas 54. Stop area 56 has a larger diameter than the two fastening areas 54, which are adjacent to stop area 56 on the right and the left.

Spacer bolt body 51 has a circumferential surface 58 in stop area 56, which has a cylindrical design and has a chamfer 60 situated on each of its lateral edges in the direction of fastening area 54. A damping system 62 is provided radially on the outside of circumferential surface 58 of spacer bolt body 51. Damping system 62 of spacer bolt 40 includes a damping element 64 of an annular design, which is situated on circumferential surface 58 of spacer bolt body 51.

Damping element 64 has an essentially rectangular cross section, bevels 65 being provided on outer circumferential surface 50. Damping element 64 is limited laterally in the axial direction by a stabilizing element 66. Stabilizing element 66 is situated in direct contact with a particular front surface 68 of damping element 64. The side surfaces of damping element 64 or stabilizing element 66 situated perpendicularly in the axial direction of longitudinal axis 52 are referred to as front surface 68 of stabilizing element 66.

For easier assembly, front surface 68 of damping element 64 is oriented perpendicularly to longitudinal axis 52 of spacer bolt 40. Stabilizing element 66 has a smaller outer diameter than damping element 64. This initially prevents stabilizing elements 66 from striking pendulum flange 34 or cutout contour 46 of cutout 44, so that the impact contact initially takes place by damping element 64 striking cutout contour 46 of pendulum flange 34.

When damping element 64 strikes cutout contour 46 of pendulum flange 34, a compression of damping element 64 occurs. To avoid or reduce an overload, due to the compression, stabilizing element 66 is able to limit the compression of damping element 64, for example in that stabilizing element 66 strikes cutout contour 46 when damping element 64 reaches a certain compression.

Due to the lateral limitation of damping element 64 by laterally situated stabilizing elements 66, a lateral deflection of damping element 64 is avoided when outer circumferential surface 50 strikes cutout contour 46 of pendulum flange 34. A possible breaking and cracking of damping element 64 is avoided thereby, so that spacer bolt 40 is more durable than known spacer bolts. The impact noise is also significantly reduced.

Damping element 64 may be made of an elastic material, in particular rubber.

Stabilizing elements 66 and damping element 64 have the same inner diameter, which is selected in such a way that damping element 64 and stabilizing elements 66 may be fastened to circumferential surface 58 of spacer bolt body 51 with the aid of a clearance fit.

The clearance fit ensures that damping system 62 is easily rotatably seated on spacer bolt body 51. For axially securing damping system 62, the latter is fixed in the assembled state in stop area 56 of spacer bolt body 51 by laterally situated pendulum masses 38.

Damping elements 64 may be connected to stabilizing element 66 using vulcanization or another integral and form-fitting connection. If damping element 64 is connected to stabilizing element 66 using vulcanization, this has the advantage that a compression stress or an internal stress may be built up in damping element 64 during vulcanization, which is maintained after the vulcanization operation. The introduced internal stress results in the fact that, when damping element 64 strikes cutout contour 46 of cutout 44 directly, the internal stress, which is aimed oppositely to the introduced impact force or impact stress induced thereby, at least partially compensates for the impact stress, so that a dynamic damping capability and an effective rigidity of damping system 62 are increased.

In this way, damping element 64 or damping system 62 may be subjected to a higher impact stress, or it has a longer service life as a result thereof. The assembly security of damping system 62 on spacer bolt body 51 is also improved.

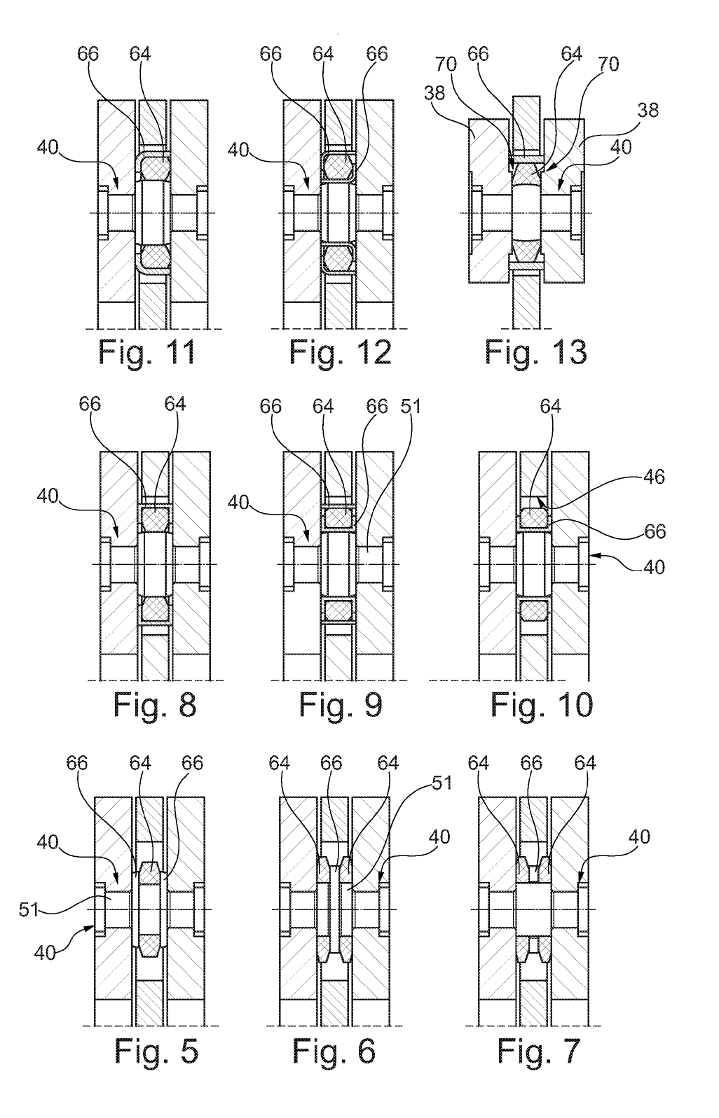

FIG. 5 shows a detail of a cross section of a centrifugal pendulum, including a spacer bolt 40 in another special specific embodiment of the present invention. Stabilizing element 66 is designed as a single piece with spacer bolt body 51.

FIG. 6 shows a detail of a cross section of a centrifugal pendulum, including a spacer bolt 40 in another special specific embodiment of the present invention. In this case, a stabilizing element 66 is introduced centrally between axially adjacent damping elements 64. Stabilizing element 66 is designed to form a single piece with spacer bolt body 51.

FIG. 7 shows a detail of a cross section of a centrifugal pendulum, including a spacer bolt 40 in another special specific embodiment of the present invention. Stabilizing element 66 is introduced as a separate component centrally between axially adjacent damping elements 64.

FIG. 8 shows a detail of a cross section of a centrifugal pendulum, including a spacer bolt 40 in another special specific embodiment of the present invention. In this case, a stabilizing element 66 encompasses a damping element 64 on an outer circumference and in sections on the front surfaces of damping element 64. Stabilizing element 66 has a U-shaped design. Stabilizing element 66 limits a compression of damping element 64 due to an impact on spacer bolt body 51.

FIG. 9 shows a detail of a cross section of a centrifugal pendulum, including a spacer bolt 40 in another special specific embodiment of the present invention. A stabilizing element 66 encompasses damping element 64 on an inner circumference which has a U-shaped design. Another stabilizing element 66 encompasses a radial outer circumference of damping element 64. If a maximum compression is reached, an impact of the two stabilizing elements 66 against each other limits further compression.

FIG. 10 shows a detail of a cross section of a centrifugal pendulum, including a spacer bolt 40 in another special specific embodiment of the present invention. In this case, a stabilizing element 66 encompasses a damping element 64 on an inner circumference and in sections on the front surfaces of damping element 64. Stabilizing element 66 has a U-shaped design. Stabilizing element 66 limits a compression of damping element 64 due to an impact on cutout contour 46.

FIG. 11 shows a detail of a cross section of a centrifugal pendulum, including a spacer bolt 40 in another special specific embodiment of the present invention. A stabilizing element 66, which encompasses damping element 64 at least in sections on an outer circumference and also at least in sections on a front surface, has an L-shaped design. If a maximum compression is reached, an impact of the radially inwardly oriented section of stabilizing element 66 on spacer bolt body 51 limits a further compression of damping element 64.

FIG. 12 shows a detail of a cross section of a centrifugal pendulum, including a spacer bolt 40 in another special specific embodiment of the present invention. A stabilizing element 66, which encompasses damping element 64 at least in sections on an outer circumference and also at least in sections on a front surface, has an L-shaped design. Another stabilizing element 66 encompasses damping element 64 at least in sections on an inner circumference and at least in sections on the other front surface of damping element 64. If a maximum compression is reached, an impact of the radially inwardly oriented section of stabilizing element 66 on other stabilizing element 66 as well as vice versa limits a further compression of damping element 64.

FIG. 13 shows a detail of a cross section of a centrifugal pendulum, including a spacer bolt 40 in another special specific embodiment of the present invention. A stabilizing element 66 encompasses an outer circumference of damping element 64 at least in sections. If a maximum compression is reached, an impact of stabilizing element 66 on a shoulder 70 in pendulum mass 38 limits further compression. Shoulder 70 may be provided as a single piece from pendulum mass 38, or it may be implemented as a separate component fastened thereto.

### LIST OF REFERENCE NUMERALS

10 torsional vibration damper
12 centrifugal pendulum
14 damper input part
16 disk carrier
18 output hub
20 toothing
22 energy storage element
24 damper intermediate part
26 energy storage element
28 damper output part
30 disk part
32 disk part
34 pendulum flange
36 turbine hub
38 pendulum mass
40 spacer bolt
42 cutout
44 cutout
46 cutout contour
50 circumferential surface
51 spacer bolt body
52 longitudinal axis
54 fastening area
56 stop area
58 circumferential surface
60 chamfer
62 damping system
64 damping element
65 bevels
66 stabilizing element
68 front surface
70 shoulder

What is claimed is:

1-10. (canceled)

11. A centrifugal pendulum comprising:
a pendulum mass pair; and
a pendulum flange, an arc-shaped cutout having a cutout contour being provided in the pendulum flange,
pendulum masses of the pendulum mass pair being situated on both sides of the pendulum flange and connected to each other with the aid of at least one spacer bolt guided through the cutout;
the spacer bolt having a damping system including at least one stabilizer and at least one elastic damper;
the damping system being designed to damp an impact of the spacer bolt on the cutout contour of the cutout, it being possible for a compression of the damper to occur due to the impact, the stabilizer limiting the compression.

12. The centrifugal pendulum as recited in claim 11 wherein the spacer bolt includes a spacer bolt body, the damper being situated on a circumferential surface of the spacer bolt body, and the stabilizer being situated on a front surface of the damper.

13. The centrifugal pendulum as recited in claim 12 wherein a further stabilizer is provided on another front surface of the damper, so that the damper is axially limited by the stabilizer.

14. The centrifugal pendulum as recited in claim 12 wherein each front surface of the damping element is encompassed at least in sections by the stabilizer, so that the damper is axially limited by the stabilizer.

15. The centrifugal pendulum as recited in claim 11 wherein the damper has a rectangular cross section.

16. The centrifugal pendulum as recited in claim 11 wherein the damper has an L-shaped cross section.

17. The centrifugal pendulum as recited in claim 11 wherein the damper has a U-shaped cross section.

18. The centrifugal pendulum as recited in claim 11 wherein the stabilizer has has a smaller outer diameter than the damper.

19. The centrifugal pendulum as recited in claim 11 wherein the stabilizer encompasses an outer circumference or an inner circumference of the damper, at least in sections.

20. The centrifugal pendulum as recited in claim 11 wherein the stabilizer has a solidity greater than a damper solidity of the damper.
